(19) United States
(12) Patent Application Publication
(10) Pub. No.: US 2006/0199650 A1
(43) Pub. Date: Sep. 7, 2006

(54) Centering device for mutually centering two shaft ends

(76) Inventors: Franz Schneider, Munich (DE); Joachim Rothe, Muhldorf (DE)

Correspondence Address: Clifford W Browning;Woodard Emhardt, Bank One Center/Tower, 11 Monument Circle Suite 3700, Indianapolis, IN, 46204-5137, US

(21) Appl. No.: 10/554,364

(22) PCT Filed: Apr. 22, 2004
(86) PCT No.: PCT/EP04/04288

§ 371 Date: Oct. 25, 2005

(30) Foreign Application Priority Data
Apr. 25, 2003 (DE) 103 18 851.7

(51) Int. Cl. F16D 3/26

(52) U.S. Cl. 464/7

(57) ABSTRACT

Centering device for the mutual centering of two shaft ends Two shaft ends (10, 20), which are in torque-transmitting connection with one another and are to a limited extent axially displaceable, rotatable and deflectable with respect to one another, are mutually centered by a stud (36), which extends axially from a first of the two shaft ends (10), and a bearing (40), which is arranged in a cavity (28) of the second shaft end (20) in the cavity (28) and receives the stud (36). The bearing (40) is composed of a central liner (42), in which the stud (36) is supported for the limited relative axial displacements and rotations of the two shaft ends (10, 20), a resilient centering socket (50), into which the liner (42) is embedded in such a manner that it accommodates relative deflections of the shaft ends (10, 20), and a ring-shaped sealing lip (52), which sealingly surrounds the stud (36) and together with the stud and the liner (42) delimits an annular lubricant space (66) on the side of the liner (42) facing the first shaft end (10). The stud (36) is, adjacent its end, encompassed by a second ring-shaped sealing lip (56), which together with the stud and the liner (42), on its side facing away from the first shaft end (10), delimits a second annular lubricant space (68). The cavity (28) is otherwise free from lubricant.

The invention relates to a centering device according to the preamble of claim 1.

One or more centering devices of this type can in particular be provided in the power train of motor vehicles. For example, numerous embodiments of vibration-dampening torsionally resilient shaft couplings are known from DE 195 31 201 A1, which are intended to be installed between a shifting-transmission and a differential of a motor vehicle. Each of these shaft couplings is provided with a bendingly and rotationally resilient coupling disk, which is arranged between two shaft ends, each provided with a flange, and connects these with one another for torque transmission. The coupling disk is ring-shaped and surrounds a centering device of the type having a cylindrical stud fixed on one of the shaft ends and a centering collar integrally formed with the second shaft end, which collar for its part encloses a resilient centering socket and an liner embedded therein for axially displaceably guiding the stud. On the side of the liner facing the first shaft end, a sealing lip integrally formed with the centering socket is arranged, which sealingly lies against the cylindrical outer surface of the stud. On the opposite side of the liner directed away from the first shaft end, the centering collar encloses a hollow space, in which the stud ends. This hollow space is limited in the direction towards the first shaft end by the interaction of the mentioned sealing lip with the stud, and in the opposite direction by a cap fitted into the centering collar. The hollow space, enclosed in this manner, is completely filled with lubricant. This generously measured lubricant filling ought to suffice for a service-life lubrication of the centering device.

In the operation of known shaft joints having a centering device of the described type, occasional out-of-balance occurrences have been observed, the cause of which has to date been attributed to manufacturing or assembly imprecisions of the coupling disk. In some cases, an unexpectedly high wear of the cylindrical stud and the central liner surrounding it was also observed; such wear has also to date been ascribed to increased local loading as a result of imbalance.

The invention, however, is based on the realization that precisely the abundantly measured amount of lubricant enclosed in the hollow space by the fitted cap mentioned is related to the observed out-of-balance and wear occurrences. The lubricant, with which the hollow space of the known centering device is filled as completely as possible during assembly, is namely exposed in operation to a piston-like effect of the stud, when the shafts, connected to one another by the centering device, perform axial relative movements against one another. A considerable pressure can thereby arise in the lubricant supply, which leads to the result that gradually ever more lubricant is squeezed out, be it by deformation of the single sealing lip present, or be it through a small central opening in the fitted cap, which closes the hollow space at its end lying opposite to the end of the stud. The lubricant, which thereby no longer completely fills the hollow space, collects as a result of the centrifugal forces occurring in operation in a radially outward edge region of the hollow space and ultimately no longer reaches the cylindrical surfaces of the stud and the central liner to be lubricated, so that in the ensuing period a higher wear occurs. The accumulation of the lubricant in the edge region of the hollow space may indeed initially be uniform in operation; with a motor vehicle at rest, however, the lubricant collects in the lower edge region with the result that it at least initially produces an imbalance during the next trip.

These previously unidentified interrelationships have led to the objective of further developing a centering device of the type mentioned at the outset in such a manner that a larger proportion of the originally filled lubricant is retained during the entire service-life of the centering device and remains capable of reaching the cylindrical surfaces of the stud and the central liner to be lubricated.

This objective is achieved according to the invention with the features of claim 1.

The inventive restriction of the lubricant supply to the two ring-shaped lubricant spaces, which are arranged one on a respective side of the liner directly adjacent same, has the advantage that with a smaller amount of lubricant can be ensured that a sufficient lubricant film between the stud and the liner is retained during the entire service-life of the centering device. Imbalance effects resulting from an uneven distribution of the lubricant in the hollow space of the second shaft end cannot arise. The two ring-shaped lubricant spaces, confined by a respective ring-shaped sealing lip, may even be filled with lubricant by the manufacturer of the centering device; with the installation of the centering device, for example during the assembly of a shaft joint arrangement, no further lubricant need be applied in the region of the centering device. Axial displacements of the stud arranged on the first shaft end with respect to the central liner receiving it on the second shaft end occurring in service are no longer able to give rise to lubricant being pushed out as a result of a pump effect of the stud in the hollow space.

Advantageous developments of the invention ensue from the dependent claims.

An embodiment of the invention is described with further details in the following on the basis of schematic drawings.

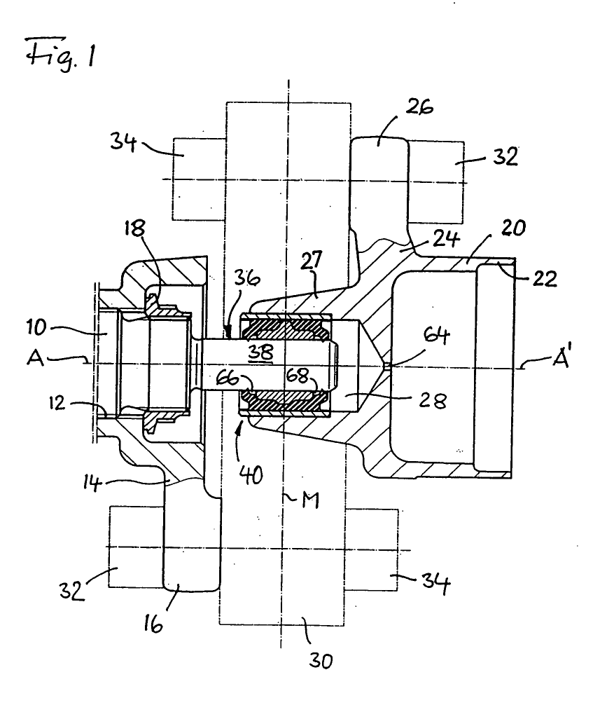

FIG. 1 is an axial section through two shaft ends flexibly connected with one another and centered with respect to one another in the drive train of a motor vehicle;

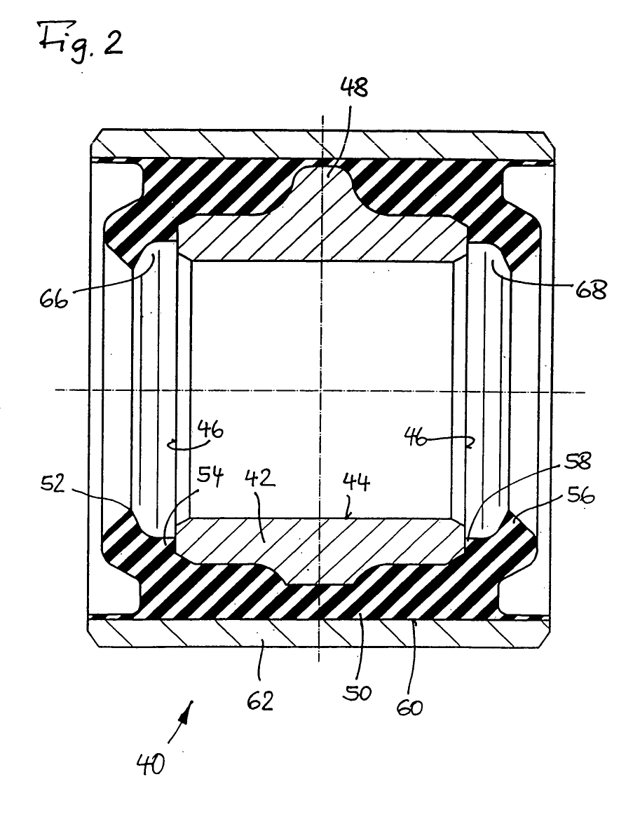

FIG. 2 is a substantially enlarged cut-out from FIG. 1

In FIG. 1, a first shaft end 10, which is part of an output shaft of a shifting transmission, is denoted. On the first shaft end 10, an external multiple-groove profile 12 is formed, which is torque-transmittingly connected with a complementary internal multiple-groove profile formed on a flange 14. The flange 14 has three radially extending arms 16 at angular intervals of 120°, is attached in the direction of the axis A of the first shaft end 10 onto same and secured by means of a screw-ring 18.

Opposite the first shaft end 10 is located a second shaft end 20, the axis A′ of which aligns with the axis A in the illustrated rest position of the shaft arrangement, to which the two shaft ends 10 and 20 belong. On the second shaft end 20, a fastening collar 22 directed away from the first shaft end 10 is formed, which is designed to be inserted together and welded with a tube-shaped shaft portion of a cardan shaft. In corresponding manner to the shaft end 10, the shaft end 20 also has a flange 24 with three radially extending arms 26, which are spaced 120° from each other and are arranged in mounted condition in the spaces with respect to the arms 16 extending from the flange 14.

Facing the first shaft end 10 is a centering collar 27 formed on the second shaft end 20, which encompasses an axial hollow space 28.

Between the arm-stars respectively formed from the three arms 16 and 26 is arranged a flexibly and rotationally resilient coupling disk 30 of known construction, which is fastened to each of the said arms 16 and 26 with a respective screw 32 and an associated nut 34. The coupling disk 30 forms a torque-transmitting connection between the two shaft ends 10 and 20, but is not, however, capable of centering these sufficiently precisely with respect to one another. The two shaft ends 10 and 20 are therefore additionally connected with one another by the centering device described in the following:

The first shaft end 10 includes an integral, axially projecting stud 36 having an external cylindrical surface 38. In the mounted condition according to FIG. 1, this stud 36 is supported in a bearing 40 attached to the second shaft end 20 in such a manner that the two shaft ends are to a limited extent with respect to one another axially displaceable, rotatable about their axes A, A′, as well as deflectable about axes that extend normal to the axes A and A′ of the two shaft ends 10 and 20 and which lie in a central plane M of the bearing 40 normal to the axis A′.

For the limited axial displacement, the stud 36 is guided in a central liner 42 of the bearing 40. The liner 42 consists of stiff, wear-resistant material having good lubrication properties, such as sintered bronze, and has a finely finished inner cylindrical surface 44, which encompasses the outer cylindrical surface 38 of the stud 36 with a radial play in an order of magnitude from 15 to 50 μm, which on the one hand ensures a sufficiently precise centering of the two shaft ends 10 and 20 with respect to one another, but on the other hand permits the formation of an uninterrupted lubricant film between the cylindrical surfaces 38 and 44. The central liner 42 has two ring-shaped end faces 46 normal to the axis A′ as well as an outer annular rib 48 arranged in the central plane M.

The central liner 42 is embedded within a resilient centering socket 50 made of rubber and is vulcanized thereto. Integrally with the centering socket 50, on its side facing the first shaft end 10, a first ring-shaped sealing lip 52 is formed, which includes an annular shoulder 54, with which it is vulcanized onto the left-hand (in FIGS. 1 and 2) ring-shaped end face 46 of the central liner 42. The first sealing lip 52 seals against the cylindrical surface 38 of the stud 36 in the interval between the central liner 42 and the screw ring 18. In corresponding fashion, a second ring-shaped sealing lip 56 is also formed integrally with the resilient centering socket 50 on the opposite side of the stud 38. The second sealing lip 56 also has an annular shoulder 58, and this is vulcanized to the right-hand (in FIGS. 1 and 2) ring-shaped end face 46 of the central liner 42 facing away from the first shaft end 10. The second sealing lip 56 sealingly surrounds the outer cylindrical surface 38 of the stud 36 in the vicinity of its right-hand free end in FIG. 1, without ever reaching it.

The resilient centering socket 50 and the two sealing lips 52 and 56 have a common cylindrical outer wall 60 which is vulcanized onto a corresponding cylindrical inner wall of a sleeve 62. As can be seen from FIG. 1, this sleeve is pressed into the centering collar 27 of the second shaft end 20, which includes a finely-finished cylindrical enlargement for this purpose.

A pressure-equalization between the hollow space 28 and the surroundings is provided for by a small axial bore 64 in the second shaft end 20. The space 28 between this bore 64 on the one hand, and the free end face of the stud 36 and the second sealing lip 56 on the other hand, contains nothing; in particular, it is not filled with lubricant. Between each of the two sealing lips 52 and 56 and the adjacent ring-shaped end faces 46 of the central liner 42, however, an annular lubricant space 66, 68 is formed in each case. These two lubricant spaces 66 and 68 communicate only with the annular space formed by the radial play between the outer cylindrical surface 38 of the stud 36 and the cylindrical inner surface 44 of the central liner 42. The volumes of the two lubricant spaces 66 and 68 are the same size and are so dimensioned, that the total volume of the two lubricant spaces and the said annular space between the cylindrical surfaces 38 and 44 in which a lubricant film forms, is approximately ten times as large as the volume of the lubricant film alone. In comparison thereto, the volume of the hollow space 28, which is maintained free from lubricant thanks to the second sealing lip 56, and which according to the prior art was more or less completely filled with lubricant is approximately two-hundred-and-forty times as large as the volume of the lubricant film confined between the cylindrical surfaces 38 and 44.

1. Centering device for the mutual centering of two shaft ends (10, 20), which are in torque-transmitting connection with one another and are to a limited extent axially displaceable, rotatable and deflectable with respect to one another, comprising:
a stud (36), which extends axially from a first of the two shaft ends (10) and terminates in a cavity (28) of the second shaft end (20),
a bearing (40), which is disposed in the cavity (28) of the second shaft end (20) and is composed of:
a central liner (42), in which the stud (36) is supported for the limited relative axial displacements and rotations of the two shaft ends (10, 20),
a resilient centering socket (50), into which the liner (42) is embedded in such a manner that it accommodates relative deflections of the shaft ends (10, 20), and
a ring-shaped sealing lip (52), which sealingly surrounds the stud (36) and together with the stud and the liner (42) delimits an annular lubricant space (66) on the side of the liner (42) facing the first shaft end (10),
characterized in that
the stud (36), proximate its end, is encompassed by a second ring-shaped sealing lip (56), which together with the stud and the liner (42) on its side facing away from the first shaft end (10) delimits a second annular lubricant space (68), and the cavity (28) is otherwise free from lubricant.

2. Centering device according to claim 1, characterized in that both sealing lips (52, 56) are manufactured in one piece with the resilient centering socket (50) from an elastomeric material.

3. Centering device according to claim 1 or 2, characterized in that both sealing lips (52, 56) and the centering socket (50) are encompassed by a common sleeve (62).

4. Centering device according to claim 3, characterized in that both sealing lips (52, 56) and the centering socket (50) are vulcanized onto the liner (42) and onto the sleeve (62).

5. Centering device according to claim 4, characterized in that both sealing lips (52, 56) emanate from a respective axially-perpendicular ring-like shoulder of the centering socket (50), which is vulcanized onto a respective end face of the liner (42).

6. Centering device according to claim 5, characterized in that the total volume of the two lubricant spaces (66, 68) and the lubricant film that forms between the stud (36) and the liner (42) is only from two to thirty times as large as the volume of the lubricant film alone.

7. Centering device according to claim 6, characterized in that the said total volume is ten times as large as the volume of the lubricant film.
